(19) United States
(12) Patent Application Publication
(10) Pub. No.: US 2012/0104177 A1
(43) Pub. Date: May 3, 2012

(54) SHOCKLESS SEPARATION DEVICE FOR SPACE APPLICATION

(75) Inventors: Jang-Sup CHOI, Daejeon-si (KR); So-Hyeun YUN, Daejeon-si (KR)

(73) Assignee: ELECTRONICS AND TELECOMMUNICATIONS RESEARCH INSTITUTE, Daejeon (KR)

(21) Appl. No.: 13/284,360

(22) Filed: Oct. 28, 2011

(30) Foreign Application Priority Data
Oct. 29, 2010 (KR) 10-2010-0107198

(51) Int. Cl. B64G 1/64

(52) U.S. Cl. 244/173.3

(57) ABSTRACT

Provided is a shockless separation device for a space application configured to fix a deployment part to a satellite while launching the satellite, and shocklessly separate the deployment part from the satellite when the satellite enters its orbit in space. The shockless separation device includes a fastening projection, a fastening recess part and a heating part. The fastening projection part is provided in the deployment part. The fastening recess part is provided in the satellite, and formed of a shape-memory alloy such that the fastening projection part is inserted into the fastening recess part to be fixed before heating, and when the fastening recess part is heated to a transformation temperature or more, the inside of the fastening recess part is recovered to be expanded to separate the fastening projection. The heating part is controlled to heat the fastening recess part when the satellite enters its orbit in space.

### CROSS-REFERENCE TO RELATED APPLICATION

This application claims the benefit under 35 U.S.C. §119(a) of Korean Patent Application No. 10-2010-0107198, filed on Oct. 29, 2010, the disclosure of which is incorporated by reference in its entirety for all purposes.

### BACKGROUND

1. Field

The following description relates to a shockless separation device for a space application, and more particularly, a shockless separation device for a space application configured to fix a deployment part to a satellite while the satellite is launched, and separate the deployment part from the satellite when the satellite enters its orbit in space.

2. Description of the Related Art

A spaceship, which operates in space, for example, a satellite, is provided with various shapes of deployment parts. For example, the satellite includes a solar cell plate having a large area to obtain electric power required to operate electronic parts in space, and a large-sized high-gain directional antenna reflective plate for communication with the ground from space. In addition, the satellite includes various shapes of observation instruments, an auxiliary radiation plate, and so on.

The satellite, in which the deployment parts are mounted, is loaded in a fairing of a projectile with the deployment parts fixedly folded upon launching. This is because the satellite can be loaded into a limited space of the fairing of the projectile with a minimum volume. When the satellite is launched and enters its orbit in space, the deployment parts are separated from the fixed state to be deployed. Since the separation/deployment of the deployment parts is a very important process for determining whether the satellite is successful in mission, a separation/deployment device for a space application must have extremely high precision and reliability.

An operation theory of a conventional separation device for a space application is as follows. When the satellite is launched, the deployment parts are fastened and fixed using explosive bolts. Each of the explosive bolts is filled with an explosive material. The amount of the explosive material is set not to affect the other parts of the satellite but enough to cut the bolt made of a metal. Then, when the satellite reaches its orbit in space, a telecommand is transmitted to the satellite from the ground, and electric power is supplied to a circuit connected to the explosive bolts. When the electric power is supplied to the explosive bolts, the explosive material is exploded to cut the bolts. Accordingly, the fixed state of the deployment parts is released. Since the exploding and cutting process has very high reliability, up to now, most of the separation devices for a space application use the above mechanism.

However, during the process of exploding and cutting the explosive bolts, since an instant shock occurs and exploded remains such as metal particles or fine powder are generated, according to circumstances, precise electronic or optical parts may be seriously damaged.

In addition, due to characteristics of the explosive bolts, once the bolts are used, the bolts cannot be reused but must be replaced with new ones. Accordingly, no matter how much the explosive bolts are tested on the ground, since an operation risk of the new explosive bolts after launching always exists, production process and quality management technique of great difficulty and high cost are needed.

### SUMMARY

The following description relates to a shockless separation device for a space application capable of separating deployment parts from a satellite with no shock and operable in space without exchange thereof even when it is tested several times on the ground.

According to an exemplary aspect, there is provided a shockless separation device for a space application configured to fix a deployment part to a satellite while launching the satellite, and shocklessly separate the deployment part from the satellite when the satellite enters its orbit in space. The device includes a fastening projection, a fastening recess part and a heating part. The fastening projection part is provided at the deployment part. The fastening recess part is provided at the satellite, and formed of a shape-memory alloy such that the fastening projection part is inserted into the fastening recess part to be fixed before heating, and when the fastening recess part is heated to a transformation temperature or more, the inside of the fastening recess part is recovered to be expanded to separate the fastening projection. The heating part is controlled to heat the fastening recess part when the satellite enters its orbit in space.

Other objects, features and advantages will be apparent from the following description, the drawings, and the claims.

### BRIEF DESCRIPTION OF THE DRAWINGS

FIG. 1 is a cross-sectional side view of a shockless separation device for a space application in accordance with a first exemplary embodiment of the present invention;

FIG. 2 is a cross-sectional side view showing a state in which a development part is assembled to a satellite by assembly bolts with a fastening projection part inserted into an expanded fastening recess part, in FIG. 1;

FIG. 3 is a cross-sectional side view showing a state in which the assembly bolts are removed after the fastening recess part is recovered and fixed to the fastening projection, in FIG. 2;

FIG. 4 is a cross-sectional side view of FIG. 3;

FIG. 5 is a plan view of FIG. 4;

FIG. 6 is a cross-sectional side view showing a process of separating the fastening projection part while the fastening recess part is expanded, in FIG. 2;

FIG. 7 is a partial cross-sectional side view of FIG. 6; and

FIG. 8 is a plan view of FIG. 7.

Elements, features, and structures are denoted by the same reference numerals throughout the drawings and the detailed description, and the size and proportions of some elements may be exaggerated in the drawings for clarity and convenience.

### DETAILED DESCRIPTION

The detailed description is provided to assist the reader in gaining a comprehensive understanding of the methods, apparatuses and/or systems described herein. Various changes, modifications, and equivalents of the systems, apparatuses, and/or methods described herein will likely suggest themselves to those of ordinary skill in the art. Also, descriptions of well-known functions and constructions are omitted to increase clarity and conciseness.

Hereinafter, an exemplary embodiment of the present invention will be described in detail with reference to the accompanying drawings.

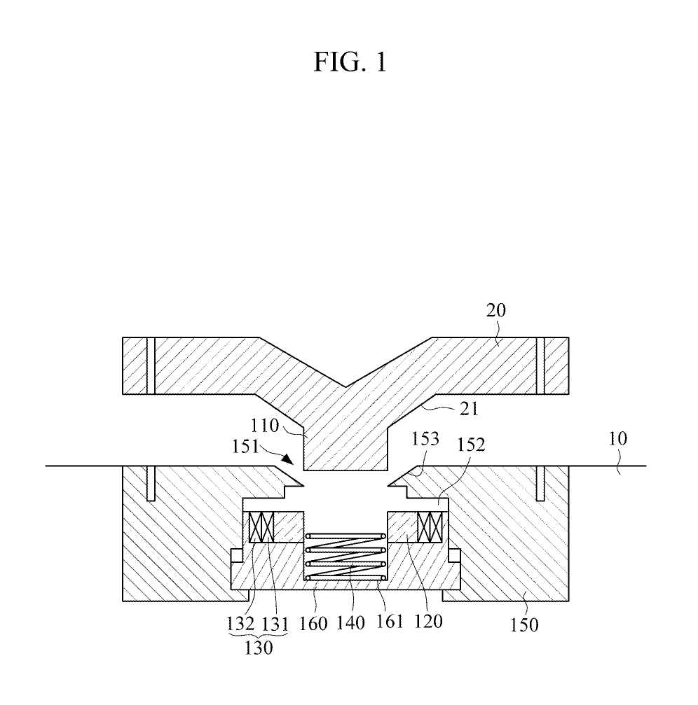

FIG. 1 is a cross-sectional side view of a shockless separation device for a space application in accordance with a first exemplary embodiment of the present invention.

Referring to FIG. 1, the shockless separation device for a space application is configured to fix a deployment part 20 to a satellite 10 during launching and shocklessly separating the deployment part 20 from the satellite 10 when the satellite 10 enters its orbit in space, and includes a fastening projection part 110, a fastening recess part 120, and a heating part 130.

The fastening projection part 110 provided from the deployment part 20. The deployment part 20 is installed at the satellite to be deployed from a state in which the deployment part 20 is loaded in a fairing of a projectile with the deployment part 20 folded to the satellite 10, when the satellite 10 enters its orbit in space. The deployment part 20 may be a solar cell plate having a large area to obtain electric power required to operate electronic part in space, a large-sized high-gain directional antenna reflective plate for communication with the ground from space, various types of observation instruments, an auxiliary radiation plate, and so on.

The fastening recess part 120 is provided at the satellite 10. The fastening recess part 120 is formed of a shape-memory alloy such that the fastening projection part 110 inserted into the fastening recess part 120 is in a fixed state before heating, and then, when the fastening recess part 120 is heated to a transformation temperature or more, the inside of the fastening recess part 120 is expanded to separate the fastening projection part 110 therefrom.

A shape-memory alloy is a material that is formed at a temperature higher than a critical temperature, i.e., a shape-memory processing temperature to memorize the shape, deformed at about room temperature without recovery to its original shape, and then, returned to its original shape when it is heated to a certain transformation temperature or more. Such deformation and recovery of the shape may be repeated many times over, and according to a certain process, the shape may be reversibly deformed by heating or cooling only. In addition, when a large recovery force is generated when the shape is recovered at a certain transformation temperature, the shape-memory alloy may be applied to a mechanical operation. The fastening recess part 120 is formed of the shape-memory alloy having the above characteristics.

The heating part 130 is controlled to heat the fastening recess part 120 when the satellite 10 enters its orbit in space. When the satellite 10 reaches its orbit in space, a telecommand is transmitted to the satellite 10 from the ground to supply electric power to the heating part 130. Then, the heating part 130 heats the fastening recess part 120 to a transformation temperature or more to expand the inside of the fastening recess part 120 to separate the fastening projection part 110. As a result, the fastening projection part 110 is separated from the fastening recess part 120 so that the deployment part 20 can be released from the state fixed to the satellite 10. Meanwhile, a resilient member 140 may be installed in the fastening recess part 120.

The resilient member 140 applies a resilient force to the fastening projection part 110 to separate the fastening projection part 110 from the fastening recess part 120. Accordingly, when the inside of the fastening recess part 120 is expanded, the fastening projection part 110 is pushed to the outside of the fastening recess part 120 by the resilient force of the resilient member 140 to be easily separated from the fastening recess part 120. The resilient member 140 may be formed of a compression coil spring, etc.

When the fastening projection part 110 is pushed by the resilient member 140, the fastening recess part 120 and the resilient member 140 may move in a direction opposite to the separation direction so as not to interfere with the deployment part 20. For this, a support frame 150 may be installed at the satellite 10. The support frame 150 has an opening 151 formed in a portion thereof in which the fastening projection part 110 is inserted. The support frame 150 may have a guide groove 152 such that the fastening recess part 120 moves to be guided in a direction opposite to the separation direction of the fastening projection part 110 with the fastening recess part 120 accommodated therein.

The support frame 150 collides with the fastening recess part 120 when the fastening recess part 120 is pushed back due to reaction upon separation of the fastening projection part 110. At this time, the support frame 150 may be finished with a shock-absorbing material to absorb shock due to the collision with the fastening recess part 120. For example, the support frame 150 may have a shock-absorbing layer formed at a portion collided with the fastening recess part 120 and made of a shock-absorbing material.

In addition, the support frame 150 may have an alignment guide part 153 configured to guide alignment of the deployment part 20 when the fastening projection part 110 is inserted into the fastening recess part 120. For example, when an inclined surface 21 is formed at the deployment part 20 from a portion of the deployment part 20 at which the fastening projection part 110 is connected to the deployment part 20, the alignment guide part 153 may be formed around the opening 151 of the support frame 150 as a surface inclined to the same angle as the inclined surface 21 of the deployment part 20. Accordingly, the deployment part 20 may be aligned and precisely assembled to the support frame 150 while seated on the alignment guide part 153.

The heating part 130 may be installed to surround the fastening recess part 120. In addition, the fastening recess part 120 may be movably accommodated in the support frame 150 while being supported on a movable block 160 together with the heating part 130. The fastening recess part 120 may have a sleeve shape with a cylindrical hollow. Further, the fastening projection part 110 may have a cylindrical shape to be inserted into the cylindrical hollow of the fastening recess part 120. When the fastening projection part 110 is manufactured as a cylindrical shape having an outer diameter D, the fastening recess part 120 may be made of a shape-memory alloy and manufactured as a sleeve shape having an inner diameter D+δ and a length L, and shape-memory treated at a high temperature between 120° C. and 150° C. The resilient member 140 may be fixed to a fixing groove 161 formed in the movable block 160 while being inserted into the hollow of the fastening recess part 120.

The heating part 130 may include a main heating part 131 and an auxiliary heating part 132 as a dual safety means. Accordingly, even when a circuit of any one of the main heating part 131 and the auxiliary heating part 132 malfunctions, the fastening projection part 110 can be reliably separated from the fastening recess part 120. The main heating part 131 and the auxiliary heating part 132 may be formed of electric heaters, respectively.

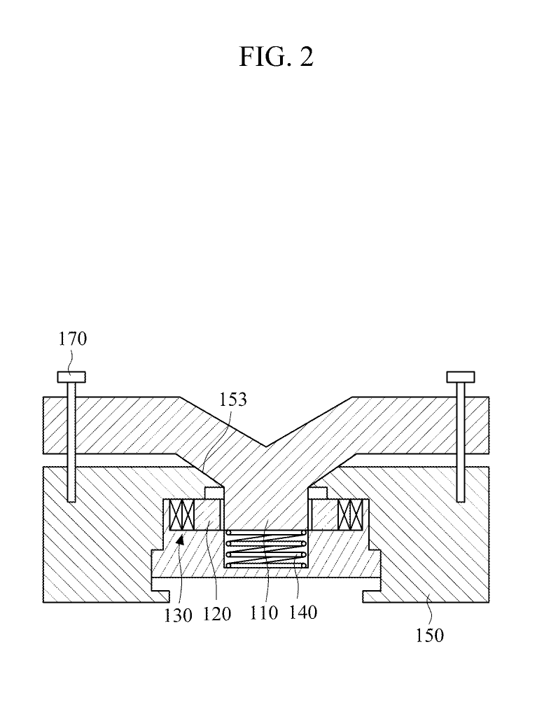

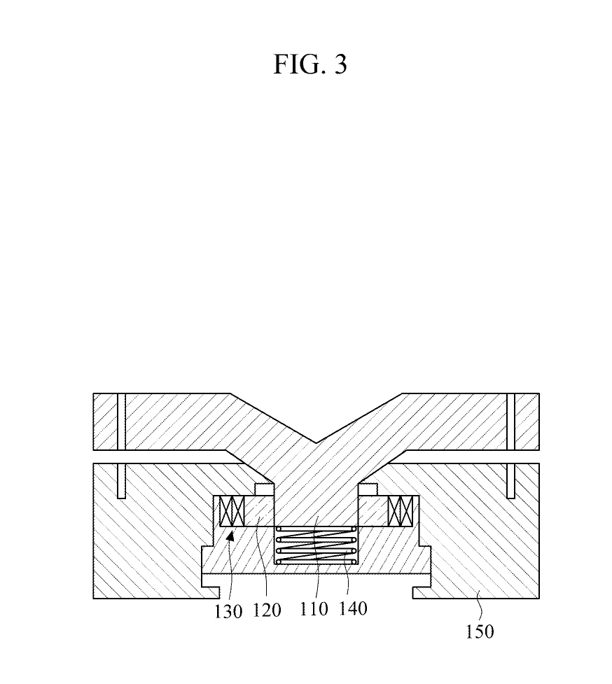

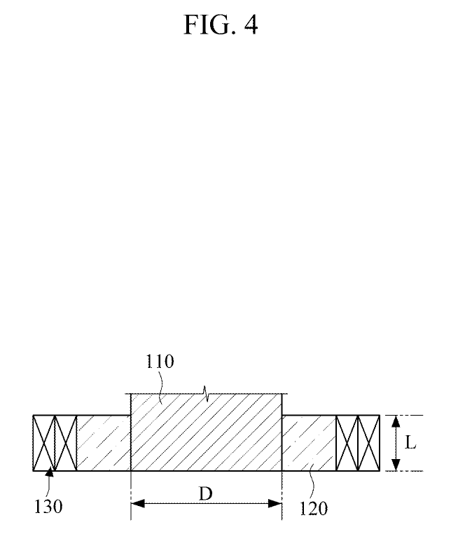

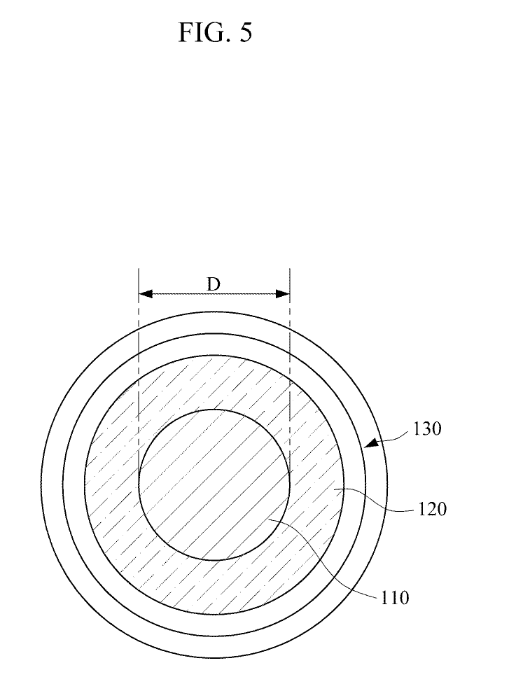

Hereinafter, a process of fixing the deployment part 20 to the satellite 10 before launching the satellite 10 will be described with reference to FIGS. 2 to 5. Here, FIG. 2 is a cross-sectional side view showing a state in which a development part is assembled to a satellite by assembly bolts with a fastening projection part inserted into an expanded fastening recess part, in FIG. 1, FIG. 3 is a cross-sectional side view showing a state in which the assembly bolts are removed after the fastening recess part is recovered and fixed to the fastening projection, in FIG. 2, FIG. 4 is a cross-sectional side view of FIG. 3, and FIG. 5 is a plan view of FIG. 4.

First, as shown in FIG. 2, when electric power is applied to the heating part 130 to heat the fastening recess part 120 to a transformation temperature or more, an inner diameter of the fastening recess part 120 is expanded to D+δ. Accordingly, since a gap corresponding to δ/2 is generated between the fastening projection part 110 and the fastening recess part 120, the fastening projection part 110 having the outer diameter D can be smoothly inserted into the fastening recess part 120. Here, the deployment part 20 is seated on the alignment guide part 153 of the support frame 150 to be aligned, and in this state, the deployment part 20 is fixed to the support frame 150 by assembly bolts 170.

Next, the electric power supplied to the heating part 130 is cut, the fastening recess part 120 is cooled and contracted to be press-fitted onto the fastening projection part 110 to fix the fastening projection part 110 using a fastening force due to contraction as shown in FIGS. 3 to 5. The fastening force required to fix the deployment part 20 upon launching of the satellite 10 may be set by adjusting the inner diameter D and the length L of the fastening recess part 120. When the fastening projection part 110 is completely fixed, the assembly bolts 170 are removed.

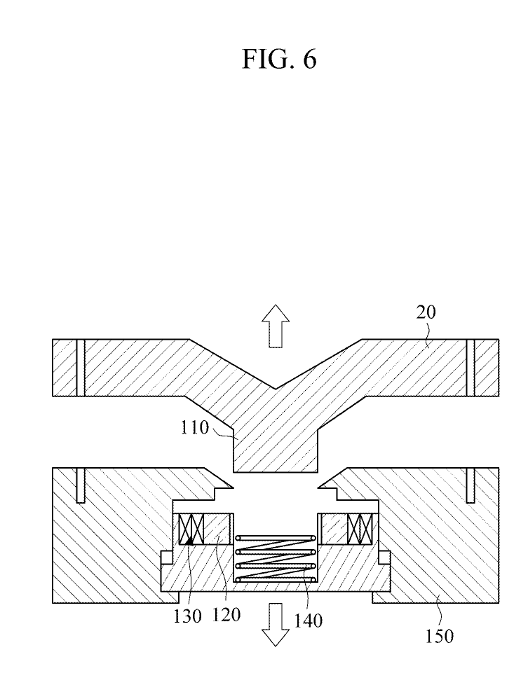

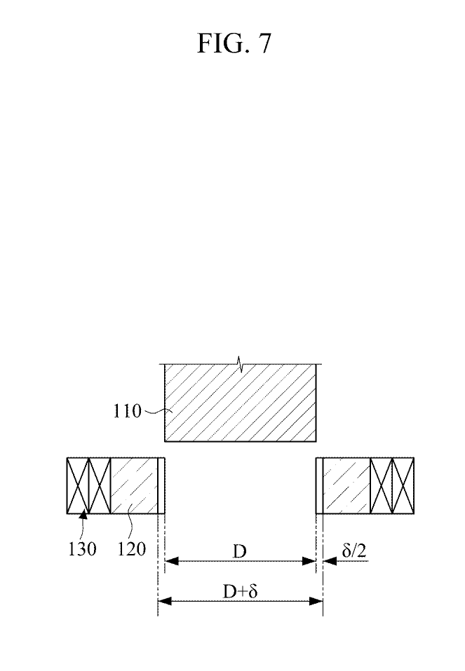

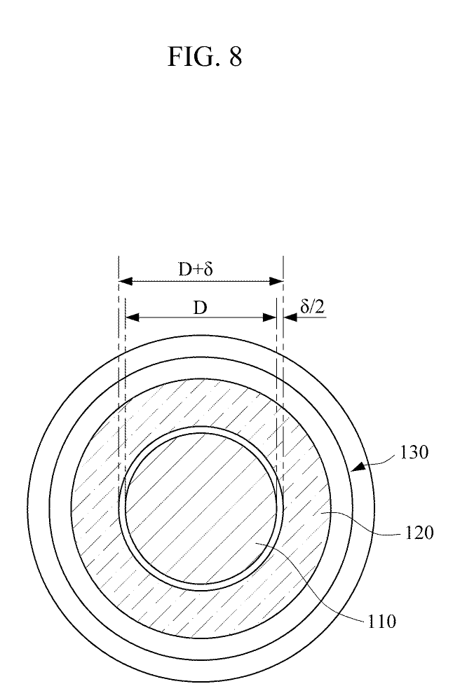

Hereinafter, a process of separating the deployment part 20 from the satellite 10 when the satellite 10 enters its orbit in space will be described with reference to FIGS. 6 to 8. FIG. 6 is a cross-sectional side view showing a process of separating the fastening projection part while the fastening recess part is expanded, in FIG. 2, FIG. 7 is a partial cross-sectional side view of FIG. 6, and FIG. 8 is a plan view of FIG. 7.

As shown in FIGS. 6 to 8, when electric power is applied to the heating part 130 according to a telecommand from the ground to heat the fastening recess part 120 to a transformation temperature or more, the fastening recess part 120 is expanded to the diameter D+δ, which is a shape-memory state. Accordingly, a gap δ/2 is generated between the fastening recess part 120 having the inner diameter D+δ and the fastening projection part 110 having the outer diameter D. Then, the fastening projection part 110 is separated from the fastening recess part 120 by the resilient force of the resilient member 140. As a result, the deployment part 20 can be separated from the satellite 10.

As described above, an expansion and contraction mechanism of the fastening recess part 120 of the present invention can be smoothly performed without reduction in performance even when it is repeated many times over. Accordingly, there are no remains due to impact and explosion generated from the conventional explosive bolts, and thus, the deployment part 20 can be separated without influence on very precise electronic parts and optical parts. In addition, since the device of the present invention has high reliability, simple operation characteristics and low level of technical difficulty, burden in production process and quality management can be reduced in comparison with the conventional explosive bolt technique.

Moreover, since the conventional explosive bolt cannot be reused but must be replaced with a new one due to characteristics of the conventional explosive bolt, no matter how much the bolt is tested on the ground, an operation risk of the new explosive bolt after launching always exists. However, since there is no need to change the shockless separation device of the present invention even when it is tested on the ground hundreds times and reliability implemented on the ground can be maintained, the operation risk can be remarkably attenuated.

Meanwhile, the shockless separation device of the present invention is not limited to the above description but may be applied to a deployment part fixed to a mother ship on the sea as well as a spaceship using a telecommand, and other various fields.

It will be apparent to those of ordinary skill in the art that various modifications can be made to the exemplary embodiments of the invention described above. However, as long as modifications fall within the scope of the appended claims and their equivalents, they should not be misconstrued as a departure from the scope of the invention itself.

What is claimed is:

1. A shockless separation device for a space application configured to fix a deployment part to a satellite while launching the satellite, and shocklessly separate the deployment part from the satellite when the satellite enters its orbit in space, the device comprising:
a fastening projection part provided at the deployment part;
a fastening recess part provided at the satellite, and formed of a shape-memory alloy such that the fastening projection part is inserted into the fastening recess part to be fixed before heating, and when the fastening recess part is heated to a transformation temperature or more, the inside of the fastening recess part is recovered to be expanded to separate the fastening projection; and
a heating part controlled to heat the fastening recess part when the satellite enters its orbit in space.

2. The shockless separation device for a space application according to claim 1, further comprising a resilient member installed in the fastening recess part to apply a resilient force in a direction that the fastening projection part is separated from the fastening recess part.

3. The shockless separation device for a space application according to claim 2, further comprising a support frame installed at the satellite such that the fastening recess part moves in a direction opposite to the separation direction of the fastening projection part to be guided upon separation of the fastening projection part with the fastening recess part accommodated in the support frame.

4. The shockless separation device for a space application according to claim 3, wherein the support frame is finished with a shock-absorbing material to attenuate impact when the fastening recess part moves in a direction opposite to the separation direction of the fastening projection.

5. The shockless separation device for a space application according to claim 3, wherein the support frame has an alignment guide part configured to guide alignment of the deployment part when the fastening projection part is inserted into the fastening recess part.

6. The shockless separation device for a space application according to claim 3, wherein the heating part is installed to surround the fastening recess part, and the fastening recess part is movably accommodated in the support frame while being supported on a movable block together with the heating part.

7. The shockless separation device for a space application according to claim 6, wherein the fastening recess part has a sleeve shape with a cylindrical hollow, and
the fastening projection part has a cylindrical shape.

8. The shockless separation device for a space application according to claim 1, wherein the heating part comprises a main heating part and an auxiliary heating part.

9. The shockless separation device for a space application according to claim 8, wherein the heating part is an electric heater.

10. The shockless separation device for a space application according to claim 1, wherein the deployment part is one selected from a solar cell plate, an antenna reflective plate, an observation instrument, and an auxiliary radiation plate.
